(19) United States
(12) Patent Application Publication
(10) Pub. No.: US 2022/0389871 A1
(43) Pub. Date: Dec. 8, 2022

(54) A PROCESS TO MINIMIZING NITROGEN OXIDES EMITTION FROM GAS TURBINE EXHAUST DUCT APPLICATIONS AND MAXIMIZING GAS TURBINE EFFICIENCY

(71) Applicant: Fuad Al Mahmood, Bahrain (BH)

(72) Inventor: Fuad Al Mahmood, Bahrain (BH)

(21) Appl. No.: 17/312,175

(22) PCT Filed: Jan. 21, 2021
(86) PCT No.: PCT/IB2021/050467

§ 371 Date: Jun. 9, 2021

(51) Int. Cl. F02C 7/143; F02C 3/22; F02C 3/30

(52) U.S. Cl. CPC F02C 7/1435; F02C 3/22; F02C 3/305; F05D 2260/212; F05D 2270/082

(57) ABSTRACT

The inventions applicable to industrial gas turbines at power plant to minimize nitrogen oxides from gas turbine exhaust and maximizing gas turbine efficiency done by replacing the standard air filter system by oxygen filtration system (O) to allow oxygen only and substituting the nitrogen by high-pressure water HPW injected in compressor (C) last stages only. The one unit of oxygen to be injected by 4 units of HPW, since air contains 5 units 4 units of nitrogen and 1 unit of oxygen, the 5 units of oxygen are to be injected by 20 units of HPW required for the process. A heat exchanger to be installed at gas turbine exhaust duct to heat the HPW injected into compressor (C) last stages, which is to be mixed with HPW at ambient/atmospheric temperature to cool compressor air outlet temperature to targeted temperature as shown in FIG. 1.
A control system is essential to control the process.

### STATEMENT OF THE PROBLEM

Atmospheric air is a composite of nitrogen and oxygen in the ratio of about 4:1 in volume.

Nitrogen oxides are formed at gas turbine combustors and others. The two most common and hazardous nitrogen oxides are nitric oxide and nitrogen dioxide. Nitrogen oxides have tremendous harsh effect on environment.

Nitrogen oxides react with substances in the atmosphere forming acid rain which have bad effects on living world and wildlife environment.

Minimizing Nitrogen from gas turbines applications leads to healthier innocuous and inoffensive environment for the living world and wildlife.

Gas turbine efficiency alone ranging between 35 to 45%. More that 50% of the energy is consumed by gas turbine compressor and the rest heat losses to the surroundings.

### CROSS-REFERENCE TO RELATED APPLICATION

This application is a continuation to PCT No. PCT/IB 2013/05445 Dated May 31, 2016 titled “Reducing compressor load consumption and maximizing gas turbine flow” the content of which are hereby incorporated by reference, and the same calculation example will be used.

### FIELD

The invention is focusing on gas turbines in power plants and similar applications to minimize nitrogen oxides emitted from gas turbine exhaust and maximizing gas turbine efficiency.

### BACKGROUND

The invention has following features.

The atmospheric air is a composite of 4 units nitrogen and 1 unit oxygen.

Replacing the air intake filter with Oxygen filters (OF) to allow only oxygen into the turbine, where the surface area of OF capable to allow 5 units of Oxygen to fulfill the compressor capacity.

The expelled nitrogen is substituted by High-Pressure Water HPW injected into compressor last stationary/stator blades only using high pressure injectors/nozzles. HPW can be injected at ambient/atmospheric temperature to reduce compressor superheated oxygen/high pressure water mixture outlet temperature to Compressor Outlet Targeted Temperature COTT to reduce the load consumed by the compressor and improve gas turbine efficiency.

The HPW temperature can also be raised ranging from atmospheric/ambient temperature up to CAOTT also reduce compressor outlet superheated oxygen/high pressure water mixture temperature to COTT to reduce the load consumed by the compressor and maximize gas turbine efficiency.

In all cases the purpose of injecting HPW into the compressor last stages is to reduce compressor outlet air to CAOTT above air saturation point, that is superheated.

A heat exchanger to be installed at gas turbine exhaust duct to heat HPW fed into the compressor through control valve. The heated HPW is to be mixed with HPW at ambient/atmospheric temperature through control valve to reduce compressor air outlet temperature to CAOTT.

This huge amount can be injected into compressor last stages since the superheated oxygen/high pressure water mixture at compressor outlet is superheated and if injected by high-pressure water at compressor outlet air saturation temperature can be raised to infinity with no risk of blade pitting or erosion.

This invention has many advantages:
1—Avoids the formation of Nitrogen oxides, minimize acidic rain, improves the environment for the living world and wildlife and maximize gas turbine efficiency.
2—Decreases compressor air outlet temperature and pressure to reduce compressor load consumption and enhancing gas turbine efficiency.
3—Raising the temperature of the injected high-pressure water to compressor outlet air targeted saturation temperature maximizes the mass of injected high-pressure water into compressor last stages.
4—HPW specific volume equals 1.5542 the specific volume of expelled Nitrogen and leads to further gas turbine efficiency enhancement.

### Short Denote of the Invention

The invention has following features.

The invention is continuous process to minimize nitrogen oxides and maximizing gas turbine efficiency.

Replacing the air intake filter with Oxygen filters (OF) to allow only oxygen into the turbine, where the surface area of OF capable to allow 5 units of Oxygen to fulfill the compressor capacity.

The expelled nitrogen is to be substituted by High-Pressure Water HPW injected into compressor last stationary/stator blades using high pressure injectors/nozzles and can be injected at ambient/atmospheric temperature to reduce compressor outlet superheated oxygen/high pressure water mixture temperature to Compressor Outlet Targeted Temperature COTT to reduce the load consumed by the compressor and improve gas turbine efficiency.

The HPW temperature can also be raised ranging from atmospheric/ambient temperature to also reduce compressor outlet superheated oxygen/high pressure water mixture temperature to COTT to reduce the load consumed by the compressor and maximize gas turbine efficiency.

In all cases the purpose of injecting HPW into the compressor to reduce compressor superheated outlet oxygen/high pressure mixture to COTT and above air saturation point.

A heat exchanger to be installed at gas turbine exhaust duct to heat HPW fed into the compressor through control valve. The heated HPW is to be mixed with HPW at ambient/atmospheric temperature through control valve to reduce compressor outlet superheated oxygen/high pressure water mixture temperature to COTT.

This invention has many advantages:

Avoids the formation of Nitrogen oxides, minimize acidic rain, improves the environment for the living world and wildlife and maximize gas turbine efficiency.

Decreasing compressor air outlet temperature and pressure to reduce compressor load consumption and enhancing gas turbine efficiency.

Raising the temperature of the injected HPW to CAOTT maximizes the mass of injected high-pressure water into compressor last stages and maximize gas turbine efficiency.

HPW specific volume equals 1.5542 the specific volume of expelled Nitrogen and leads to further gas turbine efficiency enhancement.

### DESCRIPTION OF THE KNOWN STATE OF THE ART

Atmospheric air is a composed of Nitrogen and oxygen and are burn in gas turbine combustor. Nitrogen oxides are formed in the gas turbine combustors and applications. The two most common and hazardous nitrogen oxides are nitric oxide and nitrogen dioxide.

Nitrogen oxides react with substances in the atmosphere forming acid rain which have bad effects on living world and wildlife environment.

Gas turbine efficiency alone ranging between 35 to 45%. More than 50% of the energy is consumed by gas turbine compressor and the rest heat losses to the surroundings.

### DESCRIPTION OF THE OBJECTIVE TO BE FULFILLED BY THE INVENTION

The objective to be fulfill by the invention is to minimizing nitrogen oxides emitted from gas turbine applications to achieve healthier innocuous and inoffensive environment for the living world and wildlife and maximizing gas turbine efficiency.

### DESCRIPTION OF ONE SPECIFIC EXAMPLE OR EMBODIMENT OF THE INVENTION

Though the calculation is done for specific gas turbine, similar calculations to be done for each gas turbine alone.

For a Gas turbine having the following characteristics:

T1: Compressor-air inlet temperature ° K=283° K
T2: Compressor-air outlet temperature ° K=547° K
P2: Compressor air outlet pressure=12 bar
T3: Gas turbine inlet temperature ° K=1258° K
T4: Gas turbine outlet temperature ° K=768° K
ηad: adiabatic efficiency

### Calculation

The corresponding compressor outlet air pressure and temperature is in the superheated zone. Therefore, it is safe to inject high-pressure water into compressor outlet superheated oxygen/high pressure water mixture to reduce its temperature to COTT above air saturation point, assuming compressor outlet pressure constant at 12 bar.

Compressor outlet air saturation temperature=465° K
Compressor outlet air degree of superheat=547−465=82° K
Considering temperature safety factor of =12° K

### CAOTT=547−70=477° K.

Note: Compressor outlet air will remain superheated at pressure of 12 bar and temperature of 477° K avoiding compressor blade pitting/erosion.

From Brighton cycle,

$$\begin{matrix}Turbine adiabatic efficiency η ad = 1 - ( T 4 - T 1 ) / ( T 3 - T 2 ) ⋆ 100 \\ = 1 - ( 768 - 283 ) / ( 1258 - 547 ) ⋆ 100 \\ = 1 - 485 / 711 ⋆ 100 \\ = ( 1 - 0.682 ) ⋆ 100 = 32 \%\end{matrix}$$

The adiabatic efficiency of the gas turbine ηad=32%

Table 1 below shows the improvement in the adiabatic efficiency from 32% to 38% in relation to drop in compressor outlet temperature from 547° K to 477° K.

| T2° K | 547 | 537 | 527 | 517 | 507 | 497 | 487 | 477 |
|---|---|---|---|---|---|---|---|---|
| ηad % | 32 | 33 | 34 | 35 | 35 | 36 | 37 | 38 |

From Fluid Mixture Equation

Taw=(Ma Ta+Mw Tw)/(Ma+Mw)

Therefore Mw=Ma(Ta−Taw)/(Taw−Tw)

### Where:—

Taw: Targeted air water mixture temperature=477° K
Ta: Compressor outlet temperature=547° K
Tw: Injected water temperature=288° K
Mw/Ma=Injected water mass to air mass ratio

At ambient/atmospheric temperature of 288° K Injected high-pressure water mass required to reduce compressor outlet temperature from 547° K to 477° K is Mw=0.37 Ma

The table below shows the increase in injected high-pressure water air mass ratio Mw/Ma against raise in injected high-pressure water temperature up to targeted compressor outlet air temperature 477° K.

| Tw° K | 288 | 300 | 350 | 400 | 450 | 460 | 470 | 475 | 477 |
|---|---|---|---|---|---|---|---|---|---|
| Mw/Ma | 0.37 | 0.40 | 0.55 | 0.91 | 2.59 | 4.11 | 10 | 35 | In- |
| | | | | | | | | | finity |

Table 2 showing the relationship between the rise in temperature of injected HPW (Tw) in ° K to the ratio of high-pressure water mass (Mw) injected into compressor to air mass (Ma).

The ratio of injected water (Mw) to air mass (Ma) reaches infinity at injected water temperature (Tw) of 477° K.

Gas turbine Work done Wd=M Cp ΔT

### Where:

### M=Ma+Mf+Mw

### Cp=1.188 Kj/Kg

### ΔT=1258−768=490

### M=Mf+Ma+Mw

From table 2 If Mw=0 before HPW injection

$$M = Mf + Ma Wd = ( Mf + Ma ) 1.188 ⋆ 490 = 583 ( Mf + Ma ) \qquad Equation ( Eq ) ( 1 )$$

From table 2 if Mw=0.37 Ma
If Specific volume of water=1.5542 of Nitrogen

### 0.37 Ma*1.5542=0.575 Ma

M=Mf+Ma+0.575 Ma . . . from table 1

### M=Mf+1.575 Ma

### Wd=M Cp ΔT

### Wd=(Mf+1.575 Ma) 1.188*490

Wd=583(Mf+1.575Ma) Equation (Eq) (2)

### ΔWd=Eq 2— Eq 1

### ΔWd=583 (Mf+1.575 Ma)−583 (Mf+Ma)

### ΔWd=583Mf+918.231 Ma−583 Mf−583 Ma

ΔWd=335.23Ma Equation (Eq) (3)

If Specific volume of water=1.5542 of Nitrogen
From table 2 if Mw=0.40 Ma=

### 0.4*1.5542 Ma=0.622

### Wd=M Cp ΔT

### Wd=(Mf+1.622 Ma) 1.188*490

Wd=583(Mf+1.622Ma) Equation (Eq) (4)

### ΔWd=Eq 4-Eq 1

### ΔWd=583 (Mf+1.622 Ma)−583 (Mf+Ma)

### ΔWd=583Mf+945.631 Ma−583 Mf−583 Ma

ΔWd=371.63Ma Equation (Eq) (5)

From table 2 if Mw=0.55 Ma=

### 0.55*1.5542 Ma=0.848

### Wd=M Cp ΔT

### Wd=(Mf+1.848 Ma) 1.188*490

Wd=583(Mf+1.848Ma) Equation (Eq) (6)

### ΔWd=Eq 5-Eq 1

### ΔWd=583 (Mf+1.848 Ma)−583 (Mf+Ma)

### ΔWd=583Mf+1077.384 Ma−583 Mf−583 Ma

ΔWd=494.38Ma Equation (Eq) (7)

Table 4 showing the increase in Δ Wd against Mw/Ma and Tw

| | Tw | Mw/Ma | Δ Wd | | |
|---|---|---|---|---|---|
| 1 | 288 | 0.0 | 583 (Mf + Ma) | | |
| 2 | 288 | 0.37 | 335.23 | Ma | 1 |
| 3 | 300 | 0.40 | 371.63 | Ma | 1.1 |
| 4 | 350 | 0.55 | 494.38 | Ma | 1.47 |
| 5 | 400 | 0.91 | 824.36 | Ma | 2.46 |
| 6 | 450 | 2.59 | 2349.49 | Ma | 71.2 |
| 7 | 460 | 4.11 | 3725.37 | Ma | 11.1 |
| 8 | 470 | 10 | 8477 | Ma | 25.3 |
| 9 | 475 | 35 | 31130 | Ma | 92.92 |

### DESCRIPTION OF THE REALIZATION OF THE OBJECTIVE

The objective to be fulfill by the invention is to minimizing nitrogen oxides emitted from gas turbine applications and maximizing gas turbine overall efficiency continuously.

The atmospheric air is a composite of 4 units nitrogen and 1 unit oxygen. The normal air intake filter to be replaced by Oxygen filters (OF) to allow only oxygen into the gas turbine. The surface area of OF is to be capable to allow 5 units of oxygen alone to fulfill the compressor capacity.

Four units of HPW mass required to replace each one unit of oxygen drawn by the compressor to replace the expelled units of atmospheric nitrogen. Therefore, minimum 20 units of HPW required to mix with the 5 units of oxygen drawn by the compressor to ensure good combustion at combustor.

This huge amount can be injected into compressor last stages since the air at compressor outlet is superheated and if injected by high-pressure water at compressor outlet air saturation temperature can be raised to infinity with no risk of blade pitting or erosion, a safety factor of 10 to 15 degrees to be considered.

The HPW injection system is to be capable to supply the required mass of HPW for the operation.

Compressor stationary blade carrier and compressor casing to be modified to incorporate HPW system and injectors.

Number of high-pressure injectors required to be calculated and installed between compressor stationary last stages blades as shown in FIG. 2.

The expelled nitrogen is to be substituted by HPW injected into compressor last stationary/stator blades and can be injected at ambient/atmospheric temperature to reduce compressor outlet superheated oxygen/high pressure water mixture temperature to COTT to reduce the load consumed by the compressor and enhance gas turbine efficiency.

The HPW temperature is to raised ranging from atmospheric/ambient temperature up to COTT and injected into compressor last stages to reduce the load consumed by the compressor and maximize gas turbine efficiency.

In all cases the purpose of injecting HPW into the compressor to reduce compressor outlet oxygen/high pressure mixture to COTT above compressor outlet air saturation point.

A heat exchanger to be installed at gas turbine exhaust duct as shown in FIG. 1. to heat HPW fed into the compressor through control valve.

The heated HPW is to be mixed with HPW at ambient/atmospheric temperature through control valve. The mixed HPW is injected into compressor last stationary blades only to reduce compressor oxygen/high pressure mixture outlet temperature to COTT and maximize gas turbine efficiency.

A controlling system to control the process is to be adopted to control HPW temperature and mass injected into compressor outlet superheated oxygen/high pressure water mixture at last stationary blades, COATT, and gas turbine overall efficiency.

### Implementation Requirements: —

1—Installation of Oxygen Filtration System (OFS) to replace the Air Filtration System (AFS).
2—High-pressure water injection system (HPWIS) connected only to compressor last stationary/stator blade carrier.
3—Compressor stationary blade carrier and compressor casing to be modified to incorporate high-pressure water system and injectors.
4—Number of high-pressure injectors required to be calculated and installed between compressor stationary last stages blades as shown in FIG. 2.
5—Installation of heat exchanger at gas turbine exhaust to heat the injected high-pressure water to be adopted and a by-pass and control valves to mix the HPW at atmospheric temperature with heated HPW as shown in FIG. 1.
6—A controlling system is to be adopted to control the process.

### BRIEF DESCRIPTION OF DRAWINGS

FIG. 1 Represents invention diagram to minimize Nitrogen oxides emitted from gas turbine applications and maximizing gas turbine efficiency, showing Oxygen Filter system (OF), gas turbine Compressor (C), Combustion Chamber (CC), Turbine (T), Heat Exchanger (H), Control Valves (V) and High Pressure Water Injuction system (HPWI).

FIG. 2 showing the location of HPW injectors (I) within Compressor last stages.

### DETAILED DESCRIPTION

The objective to be fulfill by the invention is to minimizing nitrogen oxides emitted from gas turbine applications and maximizing gas turbine overall efficiency continuously.

In gas turbine applications huge amount of air consumed, where atmospheric air is a composite of nitrogen and oxygen in the ratio of about 4:1. Therefore, 4 units of nitrogen is to be replaced by injected high-pressure water.

The normal air intake filter to be replaced by Oxygen filters (OF) to allow only oxygen into the gas turbine. The surface area of OF is to be capable to allow 5 units of oxygen alone to fulfill the compressor capacity.

As 4 units of HPW mass required to replace each one unit of oxygen drawn by the compressor to replace the expelled units of atmospheric nitrogen. Therefore, minimum 20 units of HPW required to mix with the 5 units of oxygen drawn by the compressor to ensure good combustion at combustor.

The HPW injection system using high pressure injectors/nozzles is to be capable to supply the required mass of HPW for the operation.

Compressor stationary blade carrier and compressor casing to be modified to incorporate HPW system and injectors.

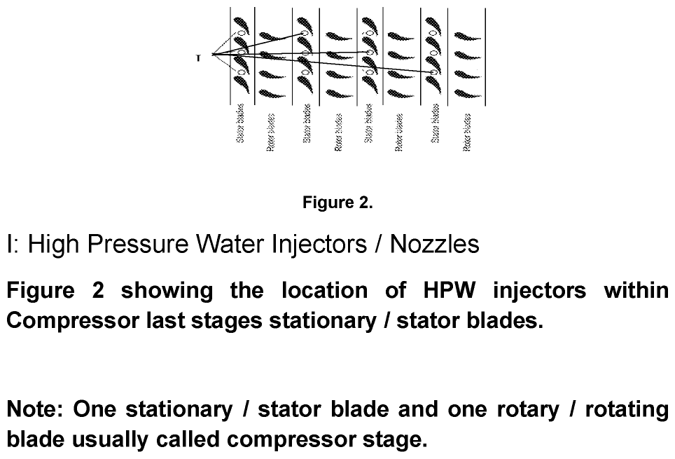

Number of high-pressure injectors required to be calculated and installed between compressor stationary last stages blades as shown in FIG. 2.

The expelled nitrogen is to be substituted by HPW injected into compressor last stationary/stator blades and can be injected at ambient/atmospheric temperature to reduce compressor air outlet temperature to COTT to reduce the load consumed by the compressor and enhance gas turbine efficiency.

The HPW temperature is to raised ranging from atmospheric/ambient temperature up to COTT and injected into compressor last stages to reduce the load consumed by the compressor and maximize gas turbine efficiency.

In all cases the purpose of injecting HPW into the compressor to reduce compressor outlet superheated oxygen/high pressure water mixture to COTT above compressor outlet air saturation point.

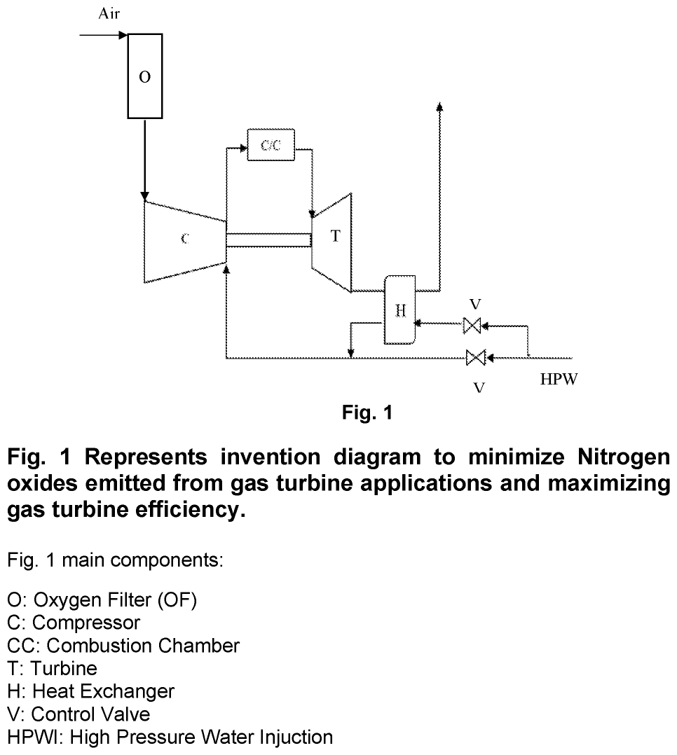

A heat exchanger to be installed at gas turbine exhaust duct as shown in FIG. 1. to heat HPW fed into the compressor through control valve.

The heated HPW is to be mixed with HPW at ambient/atmospheric temperature through control valve. The mixed HPW is injected into compressor last stationary blades only to reduce compressor oxygen/high pressure mixture outlet temperature to CAOTT and maximize gas turbine efficiency.

A controlling system to control the process is to be adopted to control HPW temperature and mass injected into compressor outlet air at last stationary blades, COTT, and gas turbine overall efficiency.

Since specific volume of water is 1.5542 of Nitrogen specific volume, then the required HPW flow rate of 20/1.5542=12.8683 unit/min of injected high-pressure water. From table 1 this can be met if the injected high-pressure water temperature between 470° K and 475° K for the invention example.

The mass of injected HPW can be increased to attain best gas turbine efficiency.

### General Notes.

As different turbines have different compressor, for each compressor the following guidelines can apply: —
1—From compressor outlet air pressure and temperature degree of superheat and air saturation point can be derived from steam table or any other means.
2—Target compressor aft outlet temperature COTT to be established above saturation point to avoid blade erosion.
3—Mass of HPW injected to lower compressor outlet air temperature targeted temperature to be calculated.
4—Number of high-pressure injectors required to lower compressor outlet aft temperature to targeted temperature to be calculated.
5—Compressor last stage blade carrier to be modified to allocate the high-pressure injectors and pipework and related control apparatuses.
6—Compressor outer casing modification to facilitate for high-pressure water injection pipework.
7—A heat exchanger to be installed at gas turbine exhaust duct to heat the HPW.
8—Compressor aft outlet temperature safety factor is decided for the process. For the above example it is 12° K.
9—Water injection rate required is to reduce compressor outlet temperature to Compressor Targeted Outlet Temperature and to be calculated and applied continuously.
10—Water injection rate required is to reduce compressor outlet temperature to Compressor Targeted Outlet Temperature and to be applied continuously.

The invention claimed is:

1. The process wherein the normal air filtration system is replaced by oxygen filtration system to admit oxygen only into the gas turbine,
Wherein the oxygen filter system capacity has equivalent or higher capacity to the replaced normal air filtration system and to fulfil compressor requirement capacity.

2. The process of claim 1, wherein said normal air filtration system is replaced by oxygen filtration system to admit oxygen only into the gas turbine,
Wherein the atmospheric 4 units of rejected/expelled nitrogen are compensated by high pressure water injected only into the compressor last stationary/stator stationary blades,
Wherein compressor outlet oxygen/high pressure mixture temperature to reduce to targeted temperature to provide superheated outlet mixture, with temperature and pressure of compressor outlet air reduced above saturation point.

3. The process of claim 2, wherein said normal air filtration system is replaced by oxygen filtration system to admit oxygen only into the gas turbine,
Wherein the atmospheric 4 units of rejected/expelled nitrogen are compensated by high pressure water injected only into the compressor last stationary/stator stationary blades,
Wherein the injected high pressure water can be injected at atmospheric temperature and/or raised within a range of temperature from atmospheric temperature up to compressor outlet air saturation point temperature.
Wherein compressor outlet oxygen/high pressure mixture temperature to reduce to targeted temperature to provide superheated outlet air, with temperature and pressure of compressor outlet air reduced above air saturation point.

4. The process of claim 3, Wherein the atmospheric 4 units of rejected/expelled nitrogen are compensated by high pressure water injected only into the compressor last stationary/stator stationary blades,
Wherein the high pressure water is injected by using injectors located only at compressor last stages between stationary blades, and the high pressure nozzles are connected to a high pressure water injecting system.
Wherein compressor outlet oxygen/high pressure mixture temperature to reduce to targeted temperature to provide superheated outlet mixture, with temperature and pressure of compressor outlet air reduced above air saturation point.

5. The process of claim 4, wherein the process for injecting high pressure water into the compressor of a gas turbine:
Wherein the injecting high pressure water is injected into only compressor last stages to reduce its outlet temperature to the targeted temperature to provide superheated outlet oxygen/high pressure mixture, with temperature and pressure of compressor outlet mixture reduced above saturation point.
Wherein the high pressure water is injected by using injectors located only at compressor last stages between stationary blades, and the high pressure nozzles are connected to a high pressure water injecting system.

6. The process of claim 5, wherein the process for injecting high pressure water into the compressor of a gas turbine,
Wherein the heated high pressure water is controlled by control valve and mixed with high pressure water at ambient temperature and controlled by control valve.
Wherein the high pressure water is injected by using injectors located only at compressor last stages between stationary/stator blades, and the high pressure nozzles are connected to a high pressure water injecting system.

7. The process of claim 1, where the normal air filtration system is replaced by oxygen filtration system to admit oxygen only into the gas turbine and the oxygen filter system capacity has equivalent or higher capacity to the replaced normal air filtration system and to fulfil compressor requirement capacity,
Wherein the 5 units of oxygen at the said compressor are injected by 20 units or higher of high pressure water injected only into the compressor last stationary/stator stationary blades,
Wherein compressor outlet oxygen/high pressure mixture at compressor outlet to reduce the oxygen/high pressure mixture temperature to targeted temperature to provide superheated outlet mixture with temperature and pressure reduced above air saturation point.

8. The process in claim 1, wherein the normal air filtration system is replaced by oxygen filtration system to admit oxygen only into the gas turbine,
Wherein the oxygen filter system capacity has equivalent or higher capacity to the replaced normal air filtration system and to fulfil compressor requirement capacity.
Wherein the huge amount can be injected into compressor last stages since the superheated oxygen/high pressure mixture at compressor outlet is superheated and if injected by high-pressure water at compressor outlet air saturation temperature can be raised to infinity with no risk of blade pitting or erosion.

9. The process in claim 1, 2, 3, 4, 5, 6 and 7 wherein the overall process is controlled by a control system.
